(19) United States
(12) Patent Application Publication
(10) Pub. No.: US 2008/0083152 A1
(43) Pub. Date: Apr. 10, 2008

(54) Length scale marked fishing rod

(76) Inventor: Xi Wang, Rochester, NY (US)

Correspondence Address: XI WANG, 60 CRITTENDEN BLVD, APT. 1322, ROCHESTER, NY, 14620, US

(21) Appl. No.: 11/975,633

(22) Filed: Oct. 22, 2007

(51) Int. Cl. A01K 87/00

(52) U.S. Cl. 43/18.1 R

(57) ABSTRACT

The invention of LENGTH SCALE MARKED FISHING ROD will be capable of being used as a standard fishing pole while also being used for measuring the length of fish subsequent to the catching. The invention would be designed very similarly to a standard fishing rod with the addition of corresponding units of length measurement markings on the rod. LENGTH SCALE MARKED FISHING ROD would be created in many different versions: engravings, drawings, or printed marks of length measurement on various types of fishing rods, which exist for different types of fishing. The measurement marks of LENGTH SCALE MARKED FISHING ROD would simply be used as other measurement devices such as rulers and tape measures are used to measure objects. The units of measurement used for LENGTH SCALE MARKED FISHING ROD could include inches and feet as well as metric length units of measurement.

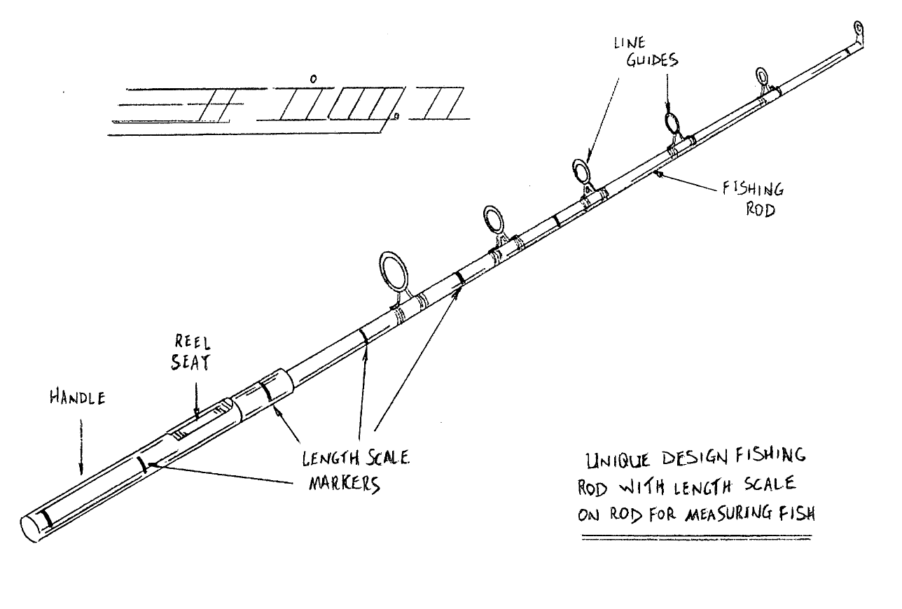

### SUMMARY OF THE INVENTION

In the spirit of progress, a concept known as LENGTH SCALE MARKED FISHING ROD, which would be capable of being used as a standard fishing pole while also being used to measure the length of fish. LENGTH SCALE MARKED FISHING ROD simply combines a measurement device with a fishing rod so that both items are not needed by the fisherman.

LENGTH SCALE MARKED FISHING ROD would be designed very similarly to a standard fishing pole with the addition of markings on the pole and corresponding units of length measurement. LENGTH SCALE MARKED FISHING ROD could be created in many different versions comparable to the various types of fishing rods, which exist for different types of fishing. LENGTH SCALE MARKED FISHING ROD would be created by engravings, drawings, or printed marks on the fishing rod.

LENGTH SCALE MARKED FISHING ROD would be extremely easy to use. The measurement marks of LENGTH SCALE MARKED FISHING ROD would simply be used as other measurement devices such as rulers and tape measures are used to measure objects. The units of measurement used for LENGTH SCALE MARKED FISHING ROD can include inches and feet as well as metric units of length measurement.

Having LENGTH SCALE MARKED FISHING ROD available to fishermen would minimize the equipment that fishermen would need to take along on a fishing trip.

### HISTORICAL DEVELOPMENT AND ADVANTAGES

To assess any new product's future acceptance and popularity, one should research the background and the need of such an innovation. This section addresses the background of the idea's conception and the problem it is designed to ease or eliminate.

Many people enjoy spending time outdoors as doing so is a good opportunity to get exercise and fresh air. Some activities that people commonly participate in outdoors include boating, camping, picnicking, and sports such as baseball, football, soccer, and tennis are usually played outdoors. Simply relaxing outdoors is also an option and there are many different settings that are appropriate for this. One's back yard, parks, and beaches are perfect settings where one can just relax and enjoy the outdoors.

The climate where one lives can have an influence on the activities that one participates in outdoors. Those who live near the beach, for instance, may partake in sailing, jet skiing, or sun bathing while those who live near the mountains may do more hiking, bird watching, or camping. Individuals who live near a body of water may enjoy fishing.

People fish for sport and pleasure as well as to catch fish for food. There are many different types of fishing, ranging from ice fishing to deep-sea fishing. Depending on the area in which one fishes and the gear that is used, various types and sizes of fish are likely to be caught. The time of year or day can also have an affect on the amount, type, and size of fish that are caught. Many fishermen measure the fish that they catch with a tape measure or ruler. Some coolers even have rulers designed in their lids so that fishermen can measure their fish on top of the cooler.

LENGTH SCALE MARKED FISHING ROD was designed for the purpose of providing fishermen with an easier and more convenient way to measure the fish they have caught. LENGTH SCALE MARKED FISHING ROD is a fishing pole that has measurement markings located on the actual pole so that fish can be measured with the fishing rod so that no additional measurement device is needed.

### INVENTION DESCRIPTION AND FUNCTIONAL OVERVIEW

To facilitate one's comprehension and understanding of a new product, that idea must be described not only as it exists as an answer to a subsisting, continuing problem, but also as it functions physically. Based upon the Inventor's description and independent research, here I describe the basic overall features, shape, design, and material used to comprise LENGTH SCALE MARKED FISHING ROD.

In the spirit of progress, the concept known as LENGTH SCALE MARKED FISHING ROD, which would be capable of being used as a standard fishing pole while also being used to measure the length of fish. LENGTH SCALE MARKED FISHING ROD simply combines a measurement device with a fishing rod so that both items are not needed by the fisherman.

LENGTH SCALE MARKED FISHING ROD would be designed very similarly to a standard fishing pole with the addition of markings on the pole and corresponding units of length measurement. LENGTH SCALE MARKED FISHING ROD could be created in many different versions comparable to the various types of fishing rods, which exist for different types of fishing. LENGTH SCALE MARKED FISHING ROD would be created by engravings, drawings, or printed marks on the fishing rod.

LENGTH SCALE MARKED FISHING ROD would be extremely easy to use. The measurement marks on LENGTH SCALE MARKED FISHING ROD would simply be used as other measurement devices such as rulers and tape measures are used to measure objects. The units of measurement used for LENGTH SCALE MARKED FISHING ROD can include inches and feet as well as metric units of length measurement.

Having LENGTH SCALE MARKED FISHING ROD available to fishermen would minimize the equipment that fishermen would need to take along on a fishing trip. LENGTH SCALE MARKED FISHING ROD would be a convenient and simple product that would be beneficial to all types of fishermen.

### PRODUCTION CONSIDERATION

Examination of LENGTH SCALE MARKED FISHING ROD through a study of production considerations, a briefly discussion of engineering guidance, materials, styles, and sizes, etc. is needed.

Companies interested in a new product consider many factors that influence the production of a product. Technology, materials, labor, overhead, and financial commitment are some of the dey factors involved in this decision-making process.

Our review of LENGTH SCALE MARKED FISHING ROD indicates that it can be manufactured using standard production of similar products. Materials, processes, and even construction techniques would be similar, with adaptations made for the specific design of LENGTH SCALE MARKED FISHING ROD. Variation on the basic model would vary in price depending upon the cost of their specific components. The materials submitted for LENGTH SCALE MARKED FISHING ROD appear to meet the standards set by the U.S. Government, i.e., OSHA, EPA, and UL.

In today's environment, the materials that are used in factories are of considerable importance. With the public awareness of clean air, clean water, and pollution, the laws governing these areas are strictly enforced. Companies, especially in the sporting goods industry, are very cautious when it comes to using materials not environmentally approved. The materials recommended by the Inventor for LENGTH SCALE MARKED FISHING ROD do not appear to be problematic.

The components of LENGTH SCALE MARKED FISHING ROD utilize standard production technology. No new research or development in this area is anticipated, nor is major retooling or materials expense expected. In effect, this provides the company with lower start-up costs, which is a major consideration for product development.

The basic concept behind LENGTH SCALE MARKED FISHING ROD appears to be sound, and the product idea is workable. The basic materials are readily available, and the concept would appeal to a vast variety of people. The design features in LENGTH SCALE MARKED FISHING ROD seem well within the limits of present-day technology.

Given the previous description of how the Invention would function and taking into consideration the questions facing further development of LENGTH SCALE MARKED FISHING ROD, it is our tentative judgment that the idea is based on sound principles and that a production version of this item could be developed to perform generally as the Inventor states.

Potential problems that might arise during the development of LENGTH SCALE MARKED FISHING ROD should be amenable to resolution normal product testing and refinement processes, after which I would anticipate that the product could be produced routinely. However, I also recommend that an interested company should be allowed to do their own form of testing and marketing and to provide modification suggestions.

Overall, since this product appears to be well thought out and potentially workable, there should be little added research or development required for the production phase of LENGTH SCALE MARKED FISHING ROD.

The design is innovative and yet relatively simple. Existing production processes and techniques will suffice without resorting to new technology. Based upon the review of the material, it is my tentative conclusion that this product can be manufactured form conventional and commercially available materials with existing production technology.

1. Length scale marks made on a fishing rod.

2. The length scale marks as measurement units of claim 1 wherein said are indicating inches.

3. The length scale marks as measurement units of claim 1 wherein said are indicating feet.

4. The length scale marks as measurement units of claim 1 wherein said are indicating yards.

5. The length scale marks as measurement units of claim 1 wherein said are indicating centimeters.

6. The length scale marks as measurement units of claim 1 wherein said are indicating meters.
